(19) United States
(12) Patent Application Publication
(10) Pub. No.: US 2021/0233409 A1
(43) Pub. Date: Jul. 29, 2021

(54) INFORMATION PROCESSING DEVICE, INFORMATION PROCESSING METHOD, STORAGE MEDIUM, AND VEHICLE

(71) Applicant: TOYOTA JIDOSHA KABUSHIKI KAISHA, Toyota-shi (JP)

(72) Inventors: Mitsuyoshi OHNO, Miyoshi-shi (JP); Daiki Kubo, Toyota-shi (JP); Yosuke Nozaki, Toyota-shi (JP); Tsukasa Nakanishi, Nagoya-shi (JP); Hironori Aoyama, Toyota-shi (JP); Seiji Yogo, Nagoya-shi (JP); Tae Sugimura, Miyoshi-shi (JP); Yasuhiro Kobatake, Nagoya-shi (JP); Takeshi Yamada, Anjo-shi (JP); Ryo Sato, Nisshin-shi (JP); Sayaka Ninoyu, Toyota-shi (JP)

(73) Assignee: TOYOTA JIDOSHA KABUSHIKI KAISHA, Toyota-shi (JP)

(21) Appl. No.: 17/138,704

(22) Filed: Dec. 30, 2020

(30) Foreign Application Priority Data
Jan. 27, 2020 (JP) 2020-010867

(51) Int. Cl. G08G 1/00; B60W 60/00; G05D 1/00

(52) U.S. Cl. CPC G08G 1/202; B60W 60/001; G05D 2201/0212; G05D 1/0027; G05D 1/0022

(57) ABSTRACT

An information processing device includes one or more processors configured to execute: instructing, to a first vehicle platform, a first operation for transporting a vehicle cabin unit which is prescribed to a prescribed place; acquiring, from the vehicle cabin unit, a degree of achievement of an activity of a user performed in the vehicle cabin unit; and instructing, to a second vehicle platform, a second operation for collecting the vehicle cabin unit when the degree of achievement exceeds a prescribed value.

### INCORPORATION BY REFERENCE

The disclosure of Japanese Patent Application No. 2020-010867 filed on Jan. 27, 2020 including the specification, drawings and abstract is incorporated herein by reference in its entirety.

### BACKGROUND

### 1. Technical Field

The disclosure relates to an information processing device, an information processing method, a storage medium, and a vehicle.

### 2. Description of Related Art

Providing services by dispatching autonomous vehicles designed for various usages have been tried. For example, Japanese Patent Application Publication No. 2019-075047 discloses a device that determines a vehicle to dispatch based on a demand for a service and working states of vehicles, and issues a moving instruction to the determined vehicle.

The vehicle, which is configured by combining a vehicle platform (chassis) and a cabin module (vehicle cabin), can meet various demands by replacement of the vehicle cabins. For example, dispatching a cabin module mounted with training equipment or fitness equipment to users enables the users to easily rent and use large-sized expensive equipment. In relation to this, Japanese Patent Application Publication No. 2017-045357 discloses a health support system configured to supply an incentive based on the degree of achievement of goals set by users.

### SUMMARY

In a system for renting individual persons equipment aiming at exercise, it is desirable to provide an environment that supports achievement of goals.

The disclosure provides a service that supports the achievement of goals in individual activities.

An information processing device according to a first aspect of the disclosure includes one or more processors configured to execute: instructing to a first vehicle platform a first operation for transporting a vehicle cabin unit which is prescribed to a prescribed place; acquiring from the vehicle cabin unit a degree of achievement of an activity of a user performed in the vehicle cabin unit; and instructing to a second vehicle platform a second operation for collecting the vehicle cabin unit when the degree of achievement exceeds a prescribed value.

An information processing method according to a second aspect of the disclosure is performed by one or more processors. The information processing method includes: a step of instructing to a first vehicle platform a first operation for transporting a vehicle cabin unit which is prescribed to a prescribed place; a step of acquiring from the vehicle cabin unit a degree of achievement of an activity of a user performed in the vehicle cabin unit; and a step of instructing to a second vehicle platform a second operation for collecting the vehicle cabin unit when the degree of achievement exceeds a prescribed value.

A vehicle according to a third aspect of the disclosure includes one or more processors configured to execute: performing a first operation for transporting a vehicle cabin unit which is prescribed to a prescribed place; acquiring from the vehicle cabin unit a degree of achievement of an activity of a user performed in the vehicle cabin unit; and performing a second operation for collecting the vehicle cabin unit when the degree of achievement exceeds a prescribed value.

Another aspect is a non-transitory storage medium storing a program for causing one or more processors to execute the information processing method.

The disclosure can provide services that support the achievement of goals in individual activities.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 shows overall configuration of a vehicle system according to a first embodiment;

FIG. 2 is an appearance view of a chassis unit and a vehicle cabin unit;

FIG. 3 shows system configuration of a server device;

FIG. 4 shows an example of chassis data and vehicle cabin data;

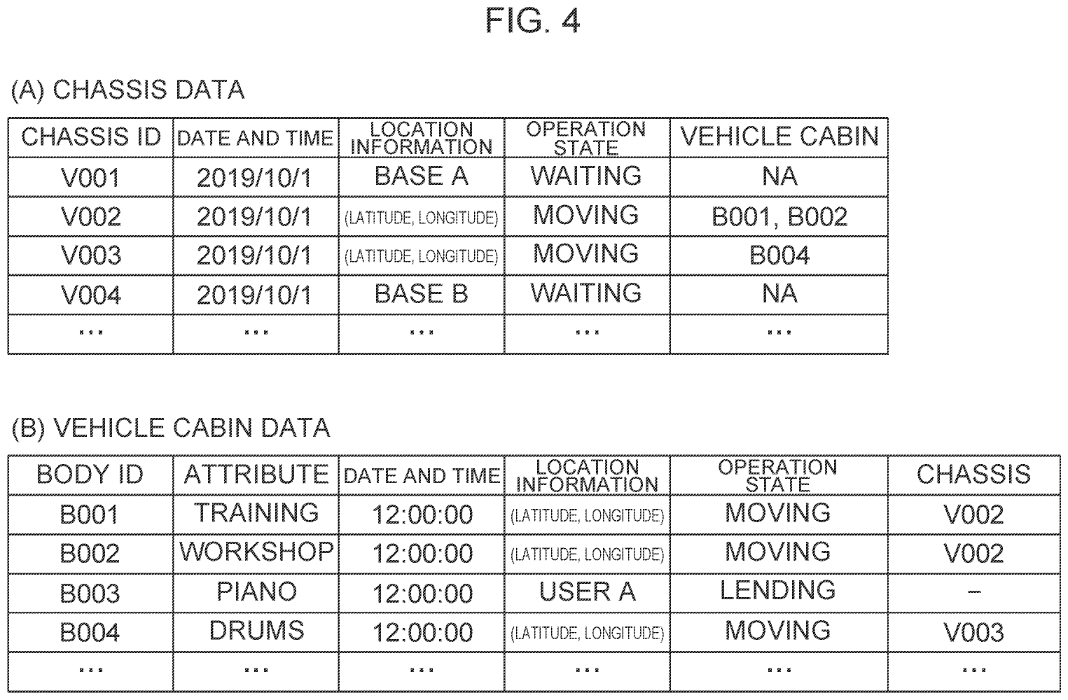

FIG. 5 shows system configuration of the vehicle cabin unit and the chassis unit;

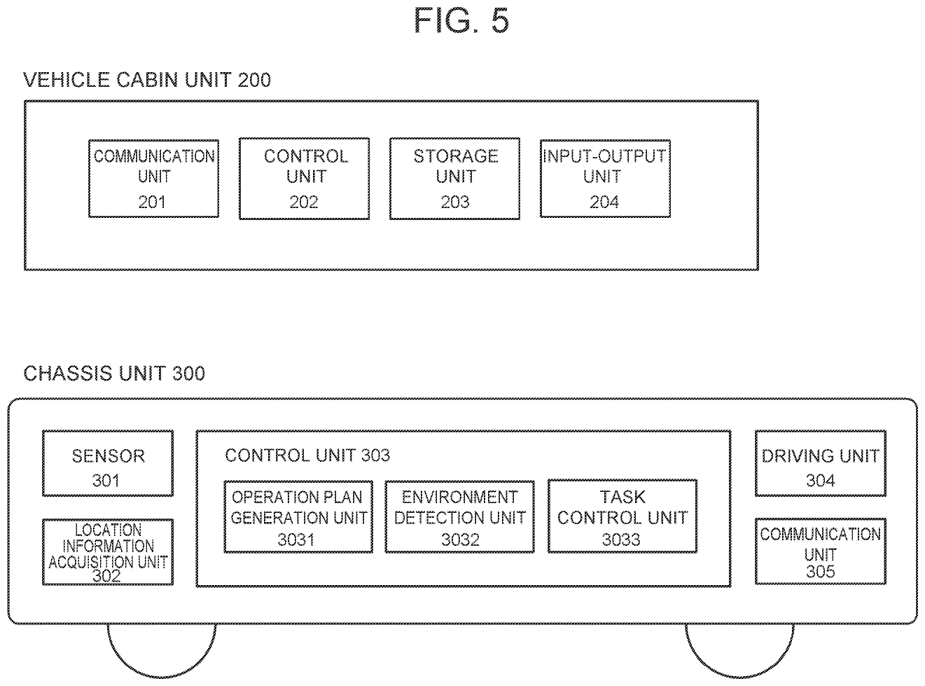

FIG. 6 is a flowchart of a process performed by the server device;

FIG. 7 is a flowchart of a process performed by the chassis unit; and

FIG. 8 is a flowchart of a process performed by the vehicle cabin unit.

### DETAILED DESCRIPTION OF EMBODIMENTS

In a system configured such that a space (vehicle cabin unit) having a prescribed function is transported by a vehicle platform and is lent to a user, an information processing device according to embodiments of the disclosure is a device that controls operation of the vehicle platform.

The vehicle platform is, for example, a mobile object including a plurality of wheels and motive power. The vehicle platform may have a function to travel, and may not necessarily need to include any rooms. The vehicle platform is configured to be mountable with one of a plurality of vehicle cabin units different in function.

Examples of the vehicle cabin units may include a unit equipped with training machines (training room), a soundproof unit equipped with musical instruments (music room), a unit equipped with tools for wood and metal working (workshop), a unit equipped with tools for vehicle maintenance (garage), and a unit for study (study room). Equipment provided by the vehicle cabin units may desirably be the equipment that is difficult for individual persons to own, such as grand pianos, processing machines, and training machines, for example. The vehicle cabin units can be separated from the vehicles and be stationarily placed. Providing the equipment in such a vehicle cabin unit enables rental of the equipment.

The information processing device according to the embodiments is a device for controlling the vehicle platform that transports such a vehicle cabin unit. Specifically, the control unit instructs to a first vehicle platform a first operation for transporting a prescribed vehicle cabin unit to a prescribed place. Based on the first operation, the prescribed vehicle cabin unit is transported to a user. The first vehicle platform does not need to stay at the place of the user with the vehicle cabin unit. For example, after the first operation is ended and the vehicle cabin unit is separated, the first vehicle platform may be allocated to another duty.

The control unit also acquires from the vehicle cabin unit a degree of achievement of an activity of the user performed in the vehicle cabin unit. The activity of the user is the activity that is achieved by lending the vehicle cabin unit, such as training, exercise, practice of musical instruments, study, and working. The degree of achievement may be transmitted from the vehicle cabin unit or from a device in the vehicle cabin unit.

The control unit then instructs to a second vehicle platform a second operation for collecting the vehicle cabin unit when the degree of achievement exceeds a prescribed value. With the configuration, the vehicle cabin unit is not collected until the degree of achievement exceeds a prescribed value, which makes it possible to motivate the user to conduct the activity. The first vehicle platform and the second vehicle platform may be different vehicle platforms, or may be the same vehicle platform.

The control unit may select the vehicle cabin unit to transport in response to a request from the user. For example, the control unit may select, out of a plurality of vehicle cabin units having different equipment, a vehicle cabin unit having the equipment corresponding to the request.

The vehicle cabin unit may include training equipment, and the control unit may select a vehicle cabin unit having training equipment in accordance with the user. The vehicle cabin unit may include training equipment, and the degree of achievement may indicate an exercise amount of the user. Such configuration enables the user to maintain motivation to exercise.

The control unit may also set a threshold of the degree of achievement in accordance with the user. For example, an appropriate exercise amount may be set as a target value in accordance with a user's attribute (for example, sex, age, height, weight, a body fat percentage, etc.).

The control unit may also generate an instruction for loading the selected vehicle cabin unit on the first vehicle platform. The instruction may be issued to the first vehicle platform or to a system that organizes the vehicles.

The vehicle cabin unit may be a vehicle cabin unit that provides an environment different from the outside, and the control unit may cause the vehicle cabin unit to perform an operation of maintaining the environment different from the outside, until the degree of achievement exceeds the prescribed value. Examples of the vehicle cabin unit that provides an environment different from the outside may include a vehicle cabin unit capable of changing oxygen concentration for highland training.

The control unit may also cause the vehicle cabin unit to perform an operation of limiting an action of the user until the degree of achievement exceeds the prescribed value. For example, it is possible to support achievement of goals by performing such operations as limiting use of devices unrelated to the activity, and limiting entering and leaving the vehicle cabin unit.

Hereinafter, the embodiments of the disclosure will be described with reference to the drawings. The configuration of the following embodiments is merely illustrative, and the disclosure is not limited to the configuration of the embodiments.

### First Embodiment

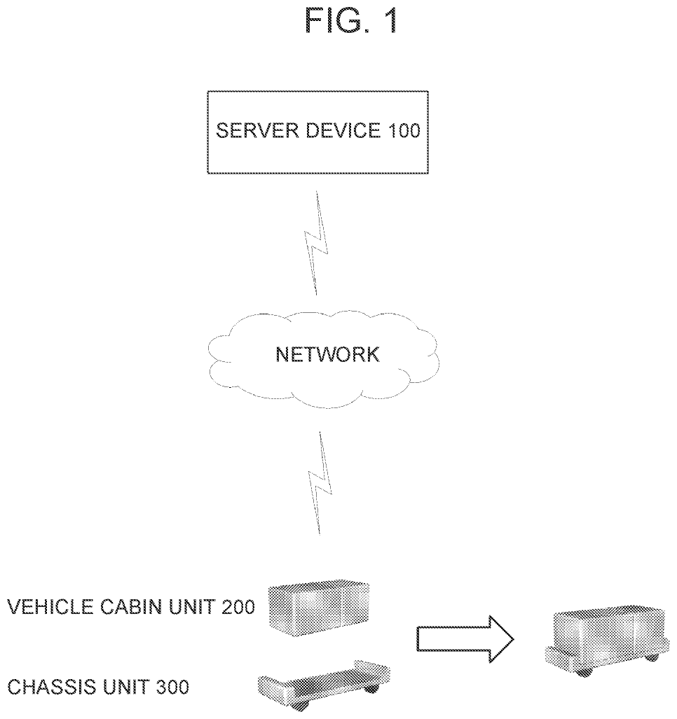

An outline of a vehicle system according to a first embodiment will be described with reference to FIG. 1. The vehicle system according to the embodiment is configured by including one or more vehicle platforms that travel autonomously based on a given instruction, one or more vehicle cabin units mounted on each vehicle platform, and a server device 100 that issues the instruction. Hereinafter, the vehicle platform is referred to as a chassis unit. The word “vehicle cabin unit” is used to collectively indicate a plurality of vehicle cabin units having different functions.

A chassis unit 300 is an autonomous vehicle that can travel with the vehicle cabin unit 200 mounted thereon. The chassis unit 300 is not necessarily an unmanned vehicle. For example, a monitoring operator or the like may be aboard. The chassis unit 300 may not necessarily be a vehicle that can perform a completely autonomous travel. For example, the chassis unit 300 may be a vehicle that is driven by a person or that provides driving assistance in accordance with situations.

Based on an instruction from the server device 100, the chassis unit 300 can load and separate the vehicle cabin unit 200. The chassis unit 300 and the vehicle cabin unit 200 belong to an operation base. The operation base can also store the chassis units 300 and the vehicle cabin units 200 which are out of operation.

The server device 100 is a device that controls a dispatch of the vehicle cabin unit 200 in response to a request from the user. The user is a consumer of a service, for example. Specifically, the server device 100, which manages the chassis units 300 and the vehicle cabin units 200, first determines which type of the vehicle cabin units 200 the user demands, and then determines a combination of the chassis unit 300 and the vehicle cabin unit 200. The server device 100 then transmits to the determined chassis unit 300 an instruction for transporting the vehicle cabin unit 200 to a prescribed place with the determined vehicle cabin unit 200 mounted thereon.

The server device 100, the vehicle cabin unit 200, and the chassis unit 300 are mutually connected through a network. As the network, a wide area network (WAN) that is a worldwide public communication network such as the Internet, or other communication networks may be adopted, for example. The network may also include telephone communication networks for cellular phones and the like, and wireless communication networks such as Wi-Fi (registered trademark).

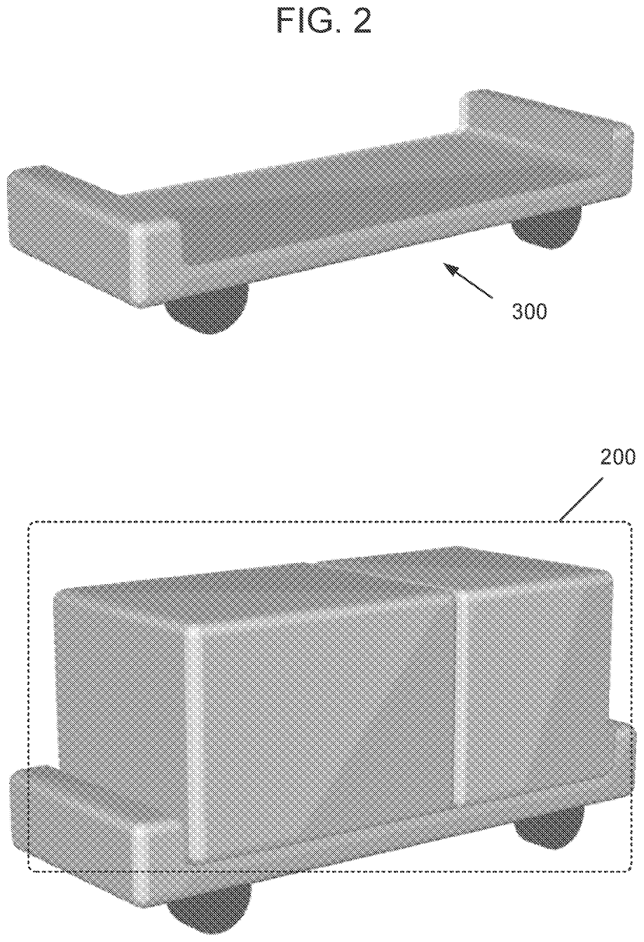

FIG. 2 is an appearance view of a vehicle. The vehicle according to the embodiment is constituted of the chassis unit 300 and the vehicle cabin unit 200.

The chassis unit 300 is a vehicle that travels autonomously by autonomous driving. The chassis unit 300 is configured by including wheels, a motor or an electric motor, a device for controlling travel, and an autonomous driving device. The chassis unit 300 travels in accordance with a prescribed instruction transmitted from a device that manages operation of the chassis unit 300. While the chassis unit 300 can move with one or more vehicle cabin units 200 mounted thereon, the chassis unit 300 can also travel without any vehicle cabin unit mounted thereon. Although the chassis unit 300 is an autonomous vehicle in the embodiment, the chassis units 300 may be a vehicle driven by a driver, or a semi-autonomous vehicle that travels under monitoring of the driver.

The vehicle cabin unit 200, which is a unit to be lent to a user, is a unit having prescribed equipment. Although examples of the prescribed equipment may include devices and equipment for training, musical instruments, machines and tools for wood and metal working, and equipment for maintenance of vehicles, the prescribed equipment may be other than these. The vehicle cabin unit 200 may have functions corresponding to the prescribed equipment. For example, a unit equipped with musical instruments may have a soundproof function. Lending the vehicle cabin unit 200 to a user enables the user to perform a prescribed activity.

In the aforementioned examples, the vehicle cabin unit 200 is mounted on the chassis unit 300. However, as long as the chassis unit 300 and the vehicle cabin unit 200 can be joined by any prescribed methods, the vehicle cabin unit 200 may not necessarily need to be laid on the chassis unit 300. The method of joining the chassis unit 300 and the vehicle cabin unit 200 is not limited to specific methods. For example, they may be joined and separated mechanically with use of a locking mechanism or the like, or may be joined and separated by using an electromagnet or the like. Examples of the method of mounting or dismounting the vehicle cabin unit 200 on or from the chassis unit 300 may include a method using a dedicated lift, and a method using a mechanism included in the chassis unit 300 or the vehicle cabin unit 200 itself. The method of mounting the vehicle cabin unit 200 on or dismounting the vehicle cabin unit 200 from the chassis unit 300 is not limited to specific methods. In the embodiment, the chassis unit 300 includes a lift so as to autonomously pick up and drop off any vehicle cabin units 200.

The server device 100 issues a command for instructing operation (hereinafter, operation instruction) to the chassis unit 300. The operation instruction includes an instruction for moving, and an instruction for installing and collecting the vehicle cabin unit 200. For example, in a prescribed operation base, the server device 100 generates an operation instruction for mounting a prescribed vehicle cabin unit 200, traveling to a prescribed destination, and dismounting and installing the vehicle cabin unit 200 after arrival at the destination. The server device 100 then transmits the generated operation instruction to the chassis unit 300.

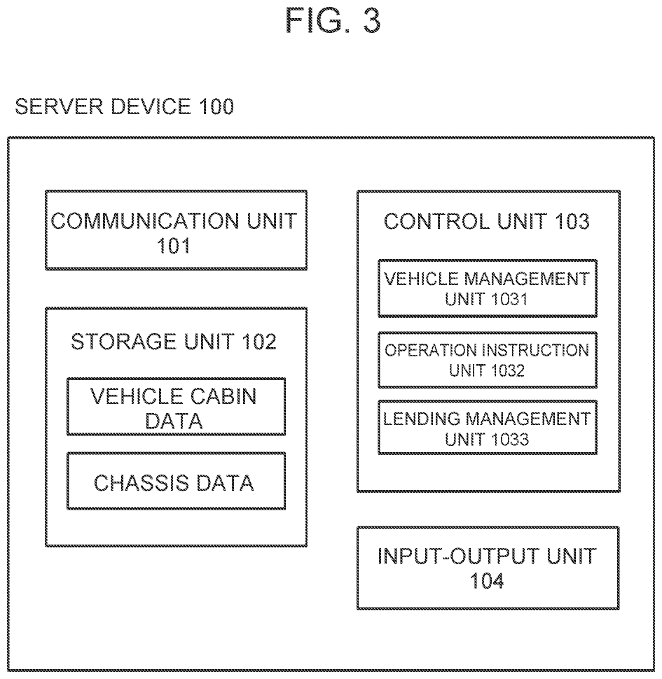

Description is now given of the details of the server device 100. FIG. 3 shows system configuration of the server device 100. The server device 100 is configured by including a communication unit 101, a storage unit 102, a control unit 103, and an input-output unit 104.

The server device 100 is constituted of a general computer. Specifically, the server device 100 is a computer including a processor such as a CPU and a GPU, a primary storage such a RAM and a ROM, and an auxiliary storage such as an EPROM, a hard disk drive, and a removable medium. The removable medium may be a USB memory or a disc recording medium such as a CD and a DVD, for example. The auxiliary storage stores an operating system (OS), various programs, various tables, and the like. The programs stored in the auxiliary storage may be loaded to a work area of the primary storage and be executed there. Through execution of the programs, each component unit and the like may be controlled such that each function matched with a prescribed purpose as described later can be implemented. However, some or all of the functions may be implemented by a hardware circuit such as an ASIC and an FPGA. The server device 100 may be constituted of a single computer, or may be constituted of a plurality of computers in cooperation with each other.

The communication unit 101 is a communication interface for connecting the server device 100 to a network. The communication unit 101 is configured by including, for example, a network interface board and a wireless communication circuit for wireless communication.

The storage unit 102 is configured by including a primary storage and an auxiliary storage. The primary storage is a memory where programs executed by the control unit 103 and data used by the control program thereof are expanded. The auxiliary storage is a device that stores programs executed in the control unit 103 and data used by the control program thereof.

The storage unit 102 further stores vehicle cabin data and chassis data. The chassis data includes location information and operation states (for example, waiting, transporting the vehicle cabin unit 200, being transferred, etc., of the chassis units 300 under management, and information identifying the vehicle cabin unit 200 mounted on each of the chassis units. The vehicle cabin data include attributes (available equipment), location information, and operation states (for example, separated, mounted on the chassis units 300 and in operation, etc.) of the vehicle cabin units 200 under management, and information identifying their counterpart chassis units 300.

The chassis data and the vehicle cabin data are periodically updated based on the information transmitted from the chassis units 300 and the vehicle cabin units 200. When each unit is in non-operating state, the information received last may be treated as the latest information.

Databases that store these data are constructed when a program of a database management system (DBMS), which is executed by the processor, manages the data stored in the storages. The databases used in the embodiment are relational databases, for example.

The control unit 103 is an arithmetic device that administers the control performed by the server device 100. The control unit 103 may be implemented by an arithmetic processing device, such as a CPU. The control unit 103 is configured by including three function modules: a vehicle management unit 1031; an operation instruction unit 1032; and a lending management unit 1033. The function modules may each be implemented by executing programs, stored in the auxiliary storage means, on the CPU.

The vehicle management unit 1031 periodically communicates with the chassis units 300 and the vehicle cabin units 200 to collect the information regarding the chassis units 300 and the vehicle cabin units 200. The collected information is reflected upon the vehicle cabin data and the chassis data.

The operation instruction unit 1032 generates an instruction (operation instruction) for operating a certain chassis unit 300. The operation instruction unit 1032 instructs the chassis unit 300 to, for example, “install a vehicle cabin unit 200 in a prescribed point and return” or “collect a vehicle cabin unit 200 from a prescribed point and return.” The chassis unit 300 travels autonomously in response to the operation instruction generated by the operation instruction unit 1032, and installs or collects the vehicle cabin unit 200.

The lending management unit 1033 manages the vehicle cabin units 200 lent to users. Specifically, the lending management unit 1033 determines to lend a prescribed vehicle cabin unit 200 to a user in response to a request made by the user. Based on the result of communication with the vehicle cabin unit 200, the lending management unit 1033 determines to collect the vehicle cabin unit 200.

When lending of a vehicle cabin unit is determined, the lending management unit 1033 generates an operation instruction for mounting the pertinent vehicle cabin unit 200 on one of the chassis units 300 and transporting the vehicle cabin unit 200 to a point specified by the user, through the operation instruction unit 1032. When collection of a vehicle cabin unit is determined, the lending management unit 1033 generates an operation instruction for collecting the vehicle cabin units 200 from a point specified by the user, through the operation instruction unit 1032.

Next, the vehicle cabin unit 200 will be described. In the embodiment, the vehicle cabin unit 200 is any one of a plurality of units that are mounted with different equipment. Here, the configuration common to the units will be described. The vehicle cabin unit 200 is configured by including a communication unit 201, a control unit 202, a storage unit 203, and an input-output unit 204. The vehicle cabin unit 200 operates with electric power supplied from a battery.

The communication unit 201 is a communication interface for communicating with the server device 100 and the chassis unit 300.

The control unit 202 is a computer that controls operation of the vehicle cabin unit. The control unit 202 is constituted of a microcomputer, for example. The control unit 202 may each be implemented by executing programs stored in the storage means, such as a read-only memory (ROM), on a central processing unit (CPU). In the embodiment, the control unit 202 is configured to be able to acquire information regarding a user's activity performed in the vehicle cabin unit 200. For example, when the vehicle cabin unit 200 functions as a training room, the control unit 202 can acquire the information regarding a user's exercise amount. When an amount of the user's activity exceeds a prescribed value, the control unit 202 requests the server device 100 to collect the vehicle cabin unit 200. A specific method will be described later.

The storage unit 203, which is means for storing information, is constituted of a storage medium, such as a RAM, a magnetic disk, and a flash memory. The input-output unit 204 is an interface for input and output of information. The input-output unit 204 is configured by including a display device and a touch panel, for example. The input-output unit 204 may include a keyboard, a camera, short-distance communication means, and a touchscreen.

Next, the chassis unit 300 will be described. The chassis unit 300 is a vehicle platform that travels in response to an operation instruction acquired from the server device 100. Specifically, the chassis unit 300 generates a travel route based on the operation instruction acquired via wireless communication, and travels on a road by an appropriate method, while sensing the periphery of the vehicle. Furthermore, the chassis unit 300 can pick up or drop off the vehicle cabin unit 200. Hence, installation and collection of the vehicle cabin unit 200 can be performed in an unmanned manner.

The chassis unit 300 is configured by including a sensor 301, a location information acquisition unit 302, a control unit 303, a driving unit 304, and a communication unit 305. The chassis unit 300 operates with the electric power supplied from a battery.

The sensor 301 is means for sensing the periphery of the vehicle. The sensor 301 is typically configured by including a stereoscopic camera, a laser scanner, a LIDAR, or a radar. The information acquired by the sensor 301 is transmitted to the control unit 303. The sensor 301 is configured by including a sensor for performing an autonomous travel. The sensor 301 may also include a camera provided in the chassis unit 300. For example, the sensor 301 may include an imaging device using an image sensor, such as a charge-coupled device (CCD), a metal-oxide semiconductor (MOS), or a complementary metal-oxide semiconductor (CMOS).

The location information acquisition unit 302 is means for acquiring a current location of the chassis unit 300. The location information acquisition unit 302 is typically configured by including a GPS receiver. The information acquired by the location information acquisition unit 302 is transmitted to the control unit 303.

The control unit 303 is a computer that controls the chassis unit 300 based on the information acquired from the sensor 301. The control unit 303 is constituted of a microcomputer, for example.

The control unit 303 has an operation plan generation unit 3031, an environment detection unit 3032, and a task control unit 3033 as function modules. The function modules may each be implemented by executing programs, stored in storage means such as a read-only memory (ROM), on a central processing unit (CPU).

The operation plan generation unit 3031 acquires an operation instruction from the server device 100, and generates an operation plan. In the embodiment, the operation plan is data that specifically defines a route to travel and a process to be performed at a moving destination.

For example, the travel route may automatically be generated with reference to map data stored in advance and based on given place of departure and destination. The travel route may also be generated by using external service. Examples of the process to be performed at the moving destination may include “separate the vehicle cabin unit 200 and install the vehicle cabin unit 200 at a specified point”, “collect the vehicle cabin unit 200”, and “notify arrival of the vehicle to the user”. However, the process is not limited to these. The operation plan generated by the operation plan generation unit 3031 is transmitted to the later-described task control unit 3033.

The environment detection unit 3032 detects the environment around the vehicle based on the data acquired by the sensor 301. Examples of detection targets include the number and location of lanes, the number and location of the vehicles present around the own vehicle, the number and location of obstacles (for example, pedestrians, bicycles, structures, buildings, and the like) present around the own vehicle, the structure of roads, and road signs. However, the detection targets are not limited to these. The detection targets may be any objects as long as the objects are necessary for autonomous travel. The environment detection unit 3032 may also track a detected object. The data regarding the environment (hereinafter, environment data) detected by the environment detection unit 3032 is transmitted to the later-described task control unit 3033.

The task control unit 3033 controls traveling of the own vehicle, based on the operation plan generated by the operation plan generation unit 3031, the environment data generated by the environment detection unit 3032, and the location information on the own vehicle acquired by the location information acquisition unit 302. For example, the task control unit 3033 makes the own vehicle travel along a prescribed route while preventing obstacles from entering into a prescribed safety area around the own vehicle. As a method of implementing an autonomous travel of the vehicle, publicly-known methods may be adopted. The task control unit 3033 may execute a task of installing or collecting the vehicle cabin unit 200, based on the operation plan (environment data generated by the environment detection unit 3032, location information regarding the own vehicle acquired by the location information acquisition unit 302, or the like, as necessary) generated by the operation plan generation unit 3031.

The driving unit 304 is means for making the chassis unit 300 travel based on an instruction generated by the task control unit 3033. The driving unit 304 is configured by including, for example, a motor, an inverter, a brake, a steering mechanism, and a secondary battery for driving the wheels. The communication unit 305 is communication means for connecting the chassis unit 300 to a network. In the embodiment, the communication unit 305 can communicate with the server device 100 and the vehicle cabin unit 200 through a network using mobile communication service, such as 3G, LTE, and 5G. The communication unit 305 may further include communication means for performing vehicle-to-vehicle communication with other vehicles.

The chassis unit 300 is mountable with the vehicle cabin unit 200 that is mounted in a vehicle cabin or on a loading platform of the chassis unit 300. The chassis unit 300 may be configured to be mountable with two or more vehicle cabin units 200. The chassis unit 300 includes a mechanism (an elevator, an actuator, a guide rail, etc.) that picks up or drops off only a prescribed vehicle cabin unit 200, out of the vehicle cabin units 200. These component members are controlled by the task control unit 3033.

The chassis unit 300 in operation periodically notifies an own status (for example, location information or the like, which is hereinafter referred to as vehicle information) to the server device 100. The server device 100 (vehicle management unit 1031) updates vehicle data using the notified information. The chassis unit 300 may transmit other information to the server device 100, for example, as illustrated below, as the vehicle information.
Size, weight, the number, etc., of mountable vehicle cabin units.
Identifier, volume, weight, etc., of vehicle cabin units currently mounted.
Current battery state of charge (SOC).
Travelable distance.
Information about operation route (in case that the chassis unit is in operation).
Information about installation or collection of vehicle cabin units.

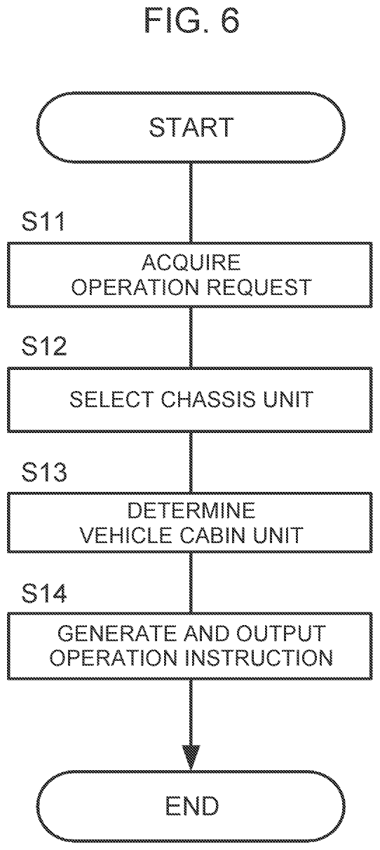

Next, a method of transporting the vehicle cabin unit will be described. FIG. 6 is a flowchart of a process in which the server device 100 generates an operation instruction based on an operation request acquired from a user.

When the user inputs an operation request to the server device 100 (step S11), the server device 100 starts to generate an operation instruction in response to the request. The operation request includes information regarding the type of a vehicle cabin unit, and information regarding a place to install the vehicle cabin unit. The type of the vehicle cabin unit may be specified directly, or may be specified indirectly. For example, “a request for a training room of a specific type” may be included in the operation request, or “a request for equipment for exercise” may be included in the operation request.

In step S12, the operation instruction unit 1032 selects the chassis unit 300 used to transport the vehicle cabin unit 200. For example, the operation instruction unit 1032 refers to the stored location information and operation state of the chassis units 300, and determines a chassis unit 300 that can provide transport service.

Next, in step S13, the lending management unit 1033 determines a vehicle cabin unit 200 to be mounted on the chassis unit 300. In this step, the lending management unit 1033 refers to the vehicle cabin data and identifies an operation base which can provide the vehicle cabin unit 200 that meets the request of the user. In this step, the vehicle cabin unit of the specified type may be selected, or the vehicle cabin unit having the equipment corresponding to the request may be selected. When there are a plurality of operation bases which can provide the vehicle cabin unit 200, the base nearest to the specified point may be selected, or the base nearest to the chassis unit 300 that is selected in step S12 may be selected. When there are a plurality of vehicle cabin units 200 that meet the user's request, the vehicle cabin units 200 may be narrowed down according to the user's attribute. For example, when the vehicle cabin units 200 different in specifications are present as candidates, those having excessive specifications may be excluded from the candidates.

In step S14, the operation instruction unit 1032 generates an operation instruction that defines the task to be performed by the chassis unit 300, and transmits the operation instruction to the chassis unit 300. The operation instruction generated here is an instruction for (1) mounting the vehicle cabin unit 200 determined by the lending management unit 1033, (2) traveling to the place specified by the user, and (3) installing the vehicle cabin unit 200 after arrival. In the embodiment, the chassis unit 300 is mounted with the vehicle cabin unit 200 by using a mechanism included in the chassis unit 300. However, in the case of mounting the vehicle cabin unit 200 using other means, an instruction for mounting the vehicle cabin unit 200 may be generated separately. For example, in the case of mounting the vehicle cabin unit 200 using a dedicated device included in the operation base, an instruction for the device may be generated in step S15.

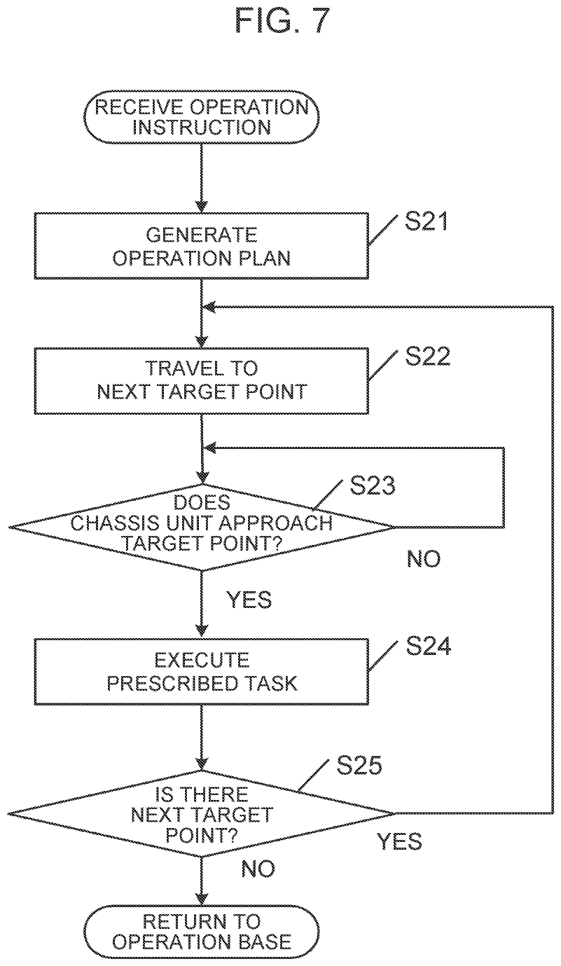

FIG. 7 is a flowchart of a process performed by the chassis unit 300 upon reception of an operation instruction. Here, the case of delivering a vehicle cabin unit 200 to the user will be described as an example. In step S21, the chassis unit 300 (operation plan generation unit 3031) generates an operation plan based on the received operation instruction. For example, the operation plan generation unit 3031 generates an operation plan including a task of identifying a route to travel (including a destination that is a transportation destination of the vehicle cabin unit 200) and moving to the destination, a task to be performed at the destination (for example, installation of the vehicle cabin unit 200 at a specified place), and a task of returning to a prescribed place.

In step S22, the task control unit 3033 starts a travel to a target point based on the generated operation plan. When the chassis unit 300 is not mounted with the vehicle cabin unit 200, the target point is an operation base where the vehicle cabin unit 200 is mounted. When the vehicle cabin unit 200 is mounted on the chassis unit 300, the target point is a transportation destination of the vehicle cabin unit 200. The vehicle information is periodically transmitted to the server device 100 even during operation.

When the chassis unit 300 approaches the target point (step S23), the task control unit 3033 searches for a place where the chassis unit 300 can stop in the vicinity of the target point, stops at the searched place, and executes the prescribed task (step S24). For example, the prescribed task may be mounting, installing, and collecting the vehicle cabin unit 200, calling the user, and the like. However, the prescribed task may be any other tasks.

Next, the task control unit 3033 determines the presence of a next target point based on the operation plan (step S25). When there is a next target point, the task control unit 3033 continues the operation of the chassis unit 300. When there is no next target point, the chassis unit 300 returns to the operation base.

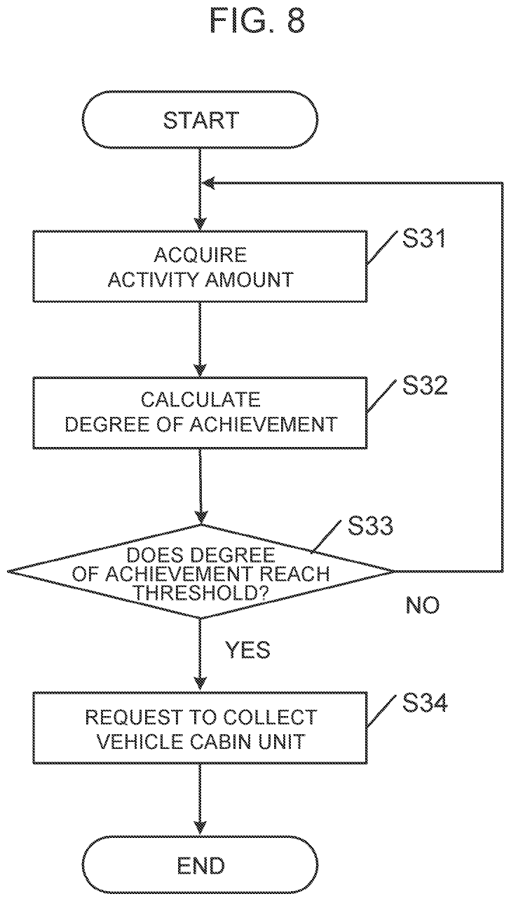

Once the vehicle cabin unit 200 is installed at the prescribed point, the user starts to use the vehicle cabin unit. FIG. 8 is a flowchart of a process performed by the vehicle cabin unit 200 (control unit 202) after the user starts to use the vehicle cabin unit.

First in step S31, the control unit 202 acquires information regarding the amount of a user's activity performed in the vehicle cabin unit 200. For example, the user's activity amount may be defined as a user's exercise amount (consumed calorie, travel distance of running or cycling, etc.) when the vehicle cabin unit 200 is a training room. In this case, the control unit 202 can acquire the exercise amount from the training devices in the vehicle cabin unit 200. The user's activity amount is not limited to the exercise amount. When the vehicle cabin unit is a work space, the user's activity amount may be a workload. When the vehicle cabin unit is a space aiming at acquisition of skill (or study), the user's activity amount may be a practice amount (learning amount). In this case, the activity amount may be acquired as a result of sensing the user's activity, or may be acquired based on a user's report. In the case where there is a plurality of types of activities (for example, running, cycling, weight training, etc.), the activity amount may be acquired for each type.

Next, in step S32, the control unit 202 calculates the degree of achievement by comparing the activity amount with a prescribed threshold. The threshold of the activity amount can be set in advance in accordance with the type of the vehicle cabin unit and the user. For example, when the vehicle cabin unit is a training room, the threshold can be set in accordance with user's sex, height, weight, BMI, body fat percentage, basal metabolism, day's target exercise amount, request from the user, or the like. When the vehicle cabin unit is a work space, the threshold can be set in accordance with the type and scale of the work. The degree of achievement may by calculated by combining the activity amounts over a plurality of days. When there are a plurality of types of activities, the degree of achievement may be calculated for each type.

Next, in step S33, the control unit 202 determines whether or not the calculated degree of achievement reaches a threshold. Here, when the degree of achievement reaches the threshold, the process proceeds to step S34. When the degree of achievement does not reach the threshold, the process returns to step S31. When there are a plurality of types of activities, the control unit 202 may determine whether all the degrees of achievement, calculated for each type, satisfied the threshold. The control unit 202 may also determine that a sum of a plurality of the degrees of achievement satisfies the threshold.

In step S34, the control unit 202 requests the server device 100 (lending management unit 1033) to collect the vehicle cabin unit 200. The lending management unit 1033 which received the request refers to the chassis data, and determines a chassis unit 300 to be dispatched to collect the vehicle cabin unit 200. The lending management unit 1033 also generates an operation instruction for collecting the vehicle cabin unit 200 through the operation instruction unit 1032, and transmits the operation instruction to the determined chassis unit 300. The chassis unit 300 which received the operation instruction executes a task of collecting the specified vehicle cabin units 200 based on the process shown in FIG. 7.

As described in the foregoing, according to the first embodiment, in the system that transports the vehicle cabin unit 200 using the chassis unit 300 and lends the pertinent vehicle cabin unit 200, it is possible to trigger collection of the vehicle cabin unit 200 based on the degree of achievement of the user's activity. With the configuration, the vehicle cabin unit is not collected until the degree of achievement exceeds a prescribed value, which makes it possible to motivate the user to do his or her activity.

### Second Embodiment

In the first embodiment, the equipment mounted on the vehicle cabin unit 200 is a lending target. However, the illustrated vehicle system is also applicable to the configuration where the vehicle cabin unit 200 itself can provide services. For example, it may be considered to provide a service by the vehicle cabin unit capable of changing the concentration of oxygen for highland training. In addition, a service may be provided by the vehicle cabin unit 200 capable of maintaining a prescribed environment. In this case, during a period of lending the vehicle cabin unit 200, the control unit 202 may perform control so as to maintain the prescribed environment. Maintaining the environment may be canceled at the timing when the degree of achievement reaches a threshold.

### Third Embodiment

In the first embodiment, collection of the vehicle cabin is triggered on condition that the degree of achievement reaches the threshold. However, the control unit 202 may perform further operation for maintaining or enhancing the user's motivation. Examples of such operation may include an operation for restricting communication with the outside by blocking or interrupting an electric wave emitted from the inside of the vehicle cabin. This makes it possible to limit the use of a mobile terminal by the user. Entering to and leaving from the vehicle cabin unit may also be limited. Thus, limiting the actions of the user unrelated to the activity that is performed in the vehicle cabin can help the user to achieve his or her goals. The operation of limiting the action of the user is ended at the timing when the degree of achievement reaches the threshold, for example.

### Fourth Embodiment

In the first embodiment, the server device 100 issues an operation instruction to the chassis unit 300. However, the chassis unit 300 may perform some or all of the determinations made by the server device 100. For example, in step S11, the user may directly request to the chassis unit 300 an operation of the chassis unit 300. In this case, execution of step S12 is omitted. Also in this case, the server device 100 may perform only the management of chassis data, and may provide data to the chassis unit 300 as necessary. In step S34, the vehicle cabin unit 200 may directly request collection of the vehicle cabin unit 200 to an optional chassis unit 300, and the chassis unit 300 may collect the vehicle cabin unit 200 in response to the request.

### Modifications

The aforementioned embodiments are merely examples, and the disclosure may appropriately be changed without departing from the meaning thereof. For example, the processes or means described in the disclosure can freely be combined and implemented without departing from the range of technical consistency.

In the description of the embodiments, a single vehicle cabin unit 200 is loaded on the chassis unit 300. However, when the chassis unit 300 has extra room, two or more vehicle cabin units 200 to be lent to a different user or users may be loaded on the chassis unit 300. The chassis unit 300 may be mounted with an optional unit (for example, a distribution unit etc.) which is not directly related to the lending service.

In description of the embodiments, the chassis unit 300 is illustrated. However, the vehicle system according to the embodiments may be applied to transportations other than the vehicle. For example, a vehicle cabin unit may be mounted on an airplane platform (Drone etc.) or a boat platform and be delivered.

Moreover, the process described to be performed by one device may be executed by a plurality of devices in cooperation with each other. Alternatively, the processes described to be executed by different devices may be executed by one device. In the computer system, hardware configuration (server configuration) that implements each function may flexibly be changed.

The disclosure can also be implemented when a computer program, mounted with the functions described in the embodiments, is supplied to a computer, and one or more processors included in the computer read and execute the program. Such a computer program may be provided to the computer by a non-transitory computer readable storage medium that is connectable with a system bus of the computer, or may be provided to the computer through a network. Examples of the non-transitory computer readable storage medium include disks and discs of any types, including magnetic disks (such as floppy (registered trademark) disks, and hard disk drives (HDDs)) and optical discs (such as CD-ROMs, DVD discs, Blu-ray disc), and media of any types suitable for storing electronic commands, including read-only memories (ROMs), random-access memories (RAMs), EPROMs, EEPROMs, magnetic cards, flash memories, and optical cards.

What is claimed is:

1. An information processing device comprising one or more processors configured to execute:
instructing, to a first vehicle platform, a first operation for transporting a vehicle cabin unit which is prescribed to a prescribed place;
acquiring, from the vehicle cabin unit, a degree of achievement of an activity of a user performed in the vehicle cabin unit; and
instructing, to a second vehicle platform, a second operation for collecting the vehicle cabin unit when the degree of achievement exceeds a prescribed value.

2. The information processing device according to claim 1, wherein the one or more processors are configured to execute allocating the first vehicle platform to another duty after the first operation is ended.

3. The information processing device according to claim 1, wherein the one or more processors are configured to execute selecting a vehicle cabin unit to transport in response to a request from the user.

4. The information processing device according to claim 1, wherein:
the vehicle cabin unit includes training equipment; and
the one or more processors are configured to execute selecting a vehicle cabin unit having training equipment in accordance with the user.

5. The information processing device according to claim 3, wherein the one or more processors are configured to execute generating an instruction for loading the vehicle cabin unit which is selected on the first vehicle platform.

6. The information processing device according to claim 1, wherein:
the vehicle cabin unit includes training equipment; and
the degree of achievement indicates an exercise amount of the user.

7. The information processing device according to claim 6, wherein the one or more processors are configured to execute setting a threshold of the degree of achievement in accordance with the user.

8. The information processing device according to claim 1, wherein:
the vehicle cabin unit is a vehicle cabin unit that provides an environment different from outside; and
the one or more processors are configured to execute causing the vehicle cabin unit to perform an operation of maintaining the environment different from the outside, until the degree of achievement exceeds the prescribed value.

9. The information processing device according to claim 1, wherein the one or more processors are configured to execute causing the vehicle cabin unit to perform an operation to limit an action of the user until the degree of achievement exceeds the prescribed value.

10. An information processing method to be executed by one or more processors, the method comprising:
instructing, to a first vehicle platform, a first operation for transporting a vehicle cabin unit which is prescribed to a prescribed place;
acquiring, from the vehicle cabin unit, a degree of achievement of an activity of a user performed in the vehicle cabin unit; and
instructing, to a second vehicle platform, a second operation for collecting the vehicle cabin unit when the degree of achievement exceeds a prescribed value.

11. The information processing method according to claim 10, further comprising allocating the first vehicle platform to another duty after the first operation is ended.

12. The information processing method according to claim 10, further comprising selecting a vehicle cabin unit to transport in response to a request from the user.

13. The information processing method according to claim 10, further comprising selecting a vehicle cabin unit having training equipment in accordance with the user.

14. The information processing method according to claim 12, further comprising generating an instruction for loading the vehicle cabin unit which is selected on the first vehicle platform.

15. The information processing method according to claim 10, wherein:
the vehicle cabin unit includes training equipment; and
the degree of achievement indicates an exercise amount of the user.

16. The information processing method according to claim 15, further comprising setting a threshold of the degree of achievement in accordance with the user.

17. The information processing method according to claim 10, further comprising causing the vehicle cabin unit to perform an operation of maintaining an environment different from outside, until the degree of achievement exceeds the prescribed value.

18. The information processing method according to claim 10, further comprising causing the vehicle cabin unit to perform an operation of limiting an action of the user until the degree of achievement exceeds the prescribed value.

19. A non-transitory storage medium storing instructions that are executable by one or more processors and that cause the one or more processors to perform functions comprising:
instructing, to a first vehicle platform, a first operation for transporting a vehicle cabin unit which is prescribed to a prescribed place;
acquiring, from the vehicle cabin unit, a degree of achievement of an activity of a user performed in the vehicle cabin unit; and
instructing, to a second vehicle platform, a second operation for collecting the vehicle cabin unit when the degree of achievement exceeds a prescribed value.

20. A vehicle, comprising one or more processors configured to execute:
performing first operation for transporting a vehicle cabin unit which is prescribed to a prescribed place;
acquiring, from the vehicle cabin unit, a degree of achievement of an activity of a user performed in the vehicle cabin unit; and
performing a second operation for collecting the vehicle cabin unit when the degree of achievement exceeds a prescribed value.
